(19) United States
(12) Patent Application Publication
(10) Pub. No.: US 2011/0042978 A1
(43) Pub. Date: Feb. 24, 2011

(54) DISPOSABLE PET WASTE REMOVAL DEVICE

(76) Inventor: Ahmed O. Elhadary, Glendale, CA (US)

Correspondence Address: CHRISTIE, PARKER & HALE, LLP, PO BOX 7068, PASADENA, CA, 91109-7068, US

(21) Appl. No.: 12/724,812

(22) Filed: Mar. 16, 2010

Related U.S. Application Data
(60) Provisional application No. 61/236,002, filed on Aug. 21, 2009.

(51) Int. Cl. A01K 29/00

(52) U.S. Cl. 294/1.3

(57) ABSTRACT

A portable, foldable, and disposable pet waste removal device that can be used by pet owners and animal keepers to remove and dispose of their pets' and animals' solid waste. A pet waste removal device according to the present invention provides an easy-to-use, easy-to-carry, pocket-size device that can be used to pick up and dispose of the animal waste in a sanitary manner. The device allows the user to avoid any contact with the animal waste by touch or feel and also to avoid exposing the waste or its residuals to the outside environment after being contained in the device.

### CROSS-REFERENCE TO RELATED APPLICATION

This application claims priority to and the benefit of U.S. Provisional Patent Application No. 61/236,002, filed on Aug. 21, 2009 in the United States Patent and Trademark Office, the entire content of which is incorporated herein by reference.

### FIELD OF THE INVENTION

Aspects of embodiments of the present invention relate to a pet waste removal device, and more particularly, to a portable, foldable, and disposable pet waste removal device.

### BACKGROUND

An inconvenient and potentially unsanitary aspect of caring for pets or other animals is the need to pick up and dispose of an animal's solid waste. Most notably, dog owners are familiar with the burden of picking up after a dog, either from one's own yard or while walking the dog. The task can be more burdensome while walking a dog because the dog generally does not leave its waste in an immediate vicinity of a garbage canister, and the owner is therefore required to carry the waste some distance in order to dispose of it.

Pet owners often pick up and dispose of pet waste using a plastic bag. However, when a plastic bag is used, the pet waste can be felt through the bag, and bacteria may pass through the bag. Additionally, when a plastic bag is used to pick up animal waste, the waste may contaminate an outer portion of the bag which may subsequently be handled by the owner while carrying the bag to a trash receptacle. Other conventional devices for scooping and disposing of animal waste are not disposable and need to be cleaned, and still other conventional devices are not portable and, therefore, are not particularly suitable for walking a dog or other animal.

### SUMMARY

According to an aspect of embodiments of the present invention, a waste removal device provides for the sanitary collection of animal solid waste. According to another aspect of embodiments of the present invention, a waste removal device is foldable, portable, pocket-sized, and disposable. According to still another aspect of embodiments of the present invention, a waste removal device eliminates the need to feel or touch the animal waste, either directly or through a bag, in order to collect and dispose of the waste in a sanitary manner.

According to one embodiment of the present invention, a waste removal device includes a base portion configured to scoop a waste product and hold the waste product thereon; a pair of side portions including respective first side portions extending from opposite sides of the base portion; and a closure portion extending from a rearward end of the base portion and extending between the side portions, wherein the side portions are connected to each other near distal ends thereof, and wherein the waste removal device is foldable between a closed state wherein the waste removal device is substantially flat and an open state wherein the first side portions extend upward from the opposite sides of the base portion and are spaced apart from each other to define an opening together with the base portion and wherein the closure portion extends upward from the rearward end of the base portion to close an end of the waste removal device opposite the opening.

In one embodiment, the base portion is joined to the respective side portions at respective first fold lines and is joined to the closure portion at a second fold line, and the waste removal device is foldable at the first and second fold lines between the closed state and the open state.

The base portion, the side portions, and the closure portion may include a substantially rigid material. The base portion, the side portions, and the closure portion may include cardboard.

In one embodiment, the side portions further include respective second side portions, the first side portions are joined to the respective second side portions at respective first side portion fold lines, and the side portions are foldable at the respective first side portion fold lines between the closed state and the open state, and the side portions are connected to each other at the second side portions. The second side portions may include respective second side portion fold lines, and the second side portions may be foldable at the respective second side portion fold lines between the closed state and the open state. In one embodiment, the side portions are stapled to each other.

In one embodiment, the closure portion includes a center portion and a pair of wing portions extending from opposite sides of the center portion, and the wing portions are joined to the center portion at respective closure portion fold lines, and the wing portions are foldable relative to the center portion at the respective closure portion fold lines between the closed state and the open state. In one embodiment, the wing portions are joined to the respective first side portions at respective wing portion fold lines, and the wing portions are foldable relative to the respective first side portions at the respective wing portion fold lines between the closed state and the open state, and the wing portions are substantially parallel to the respective first side portions when the waste removal device is in the open state.

In one embodiment, the base portion is joined to the respective side portions at respective first fold lines and is joined to the closure portion at a second fold line, and the waste removal device is foldable at the first and second fold lines between the closed state and the open state, the closure portion includes a center portion and a pair of wing portions extending from opposite sides of the center portion, and the wing portions are joined to the center portion at respective closure portion fold lines and are joined to the respective first side portions at respective wing portion fold lines, and the wing portions are foldable relative to the center portion at the respective closure portion fold lines and are foldable relative to the respective first side portions at the respective wing portion fold lines between the closed state and the open state. The second fold line, the closure portion fold lines, and the wing portion fold lines may be perforated.

According to another embodiment of the present invention, a waste removal device includes a scooper portion including a base portion configured to scoop a waste product and hold the waste product thereon; a pair of side portions extending upward from opposite sides of the base portion and spaced apart from each other to define an opening of the scooper portion together with the base portion; and a closure portion extending upward from a rearward end of the base portion and extending between the side portions to close an end of the scooper portion opposite the opening; and a bag portion coupled to the scooper portion. The scooper portion may be receivable in the bag portion. The waste removal device may be foldable into a substantially flat shape. The scooper portion may include cardboard. The side portions and the bag portion may be stapled to each other.

According to another embodiment of the present invention, a method of using a waste removal device including a scooper portion having a base portion, a pair of side portions extending from opposite sides of the base portion, and a closure portion extending from a rearward end of the base portion includes: unfolding the scooper portion from a folded state to an unfolded state wherein the side portions extend upward from the base portion and are spaced apart from each other to define an opening of the scooper portion together with the base portion; pushing the closure portion inward toward the opening to close the rearward end of the scooper portion; and scooping a waste product onto the base portion through the opening. Pushing the closure portion inward toward the opening to close the rearward end of the scooper portion may include folding the closure portion at a perforated fold line thereof. The method may further include opening a bag portion coupled to the scooper portion; inserting a hand inside the bag portion; and holding the scooper portion with the hand inside the bag portion. The method may further include inverting the bag portion and pulling the scooper portion into the bag portion while removing the hand from the bag portion.

According to one embodiment of the invention, a waste removal device is composed of two components that are attached to each other. The first component is a foldable shovel-shaped scooper that may be made of card-stock paper and is used to pick up the waste. The second component is a plastic bag that is used to cover a user's hand when using the device and contain the used scooper with the collected waste. The scooper is made of one piece of folded card-stock paper that, when it is unfolded, takes the shape of a shovel with two openings and two handles. The back opening has a foldable flap that folds upward to close it and hold the scooper in its final shovel shape. The front opening is used to pick up the waste. The two handles of the scooper are attached to the plastic bag and are used by the user to hold the device while picking up the waste. The whole device (the scooper and the bag) are foldable and disposable. The device will be available to the user in the folded condition. The device, in its folded condition, is designed to fit in a pocket of the user's garment. To use the device, the user will unfold the device, insert one hand into the plastic bag, hold the handles of the scooper, fold the back flap of the scooper upward to close its back opening, and proceed with picking up the waste by scooping and directing the waste into the front opening of the scooper. When the waste pick-up is complete, the user will use the other hand to remove the plastic bag from around the first hand that is holding the used scooper, reverse the bag in the process, and contain the used scooper inside the bag along with the collected waste. The user will then close the bag by tying the corners of its opening and dispose of the entire used device into an appropriate waste disposal container.

Additional aspects and/or advantages of embodiments of the present invention are set forth in the following description and accompanying drawings, or may be obvious in view thereof to those skilled in the art.

### BRIEF DESCRIPTION OF THE DRAWINGS

The above and other features and advantages will become more apparent to those of ordinary skill in the art by describing in detail some exemplary embodiments of the present invention with reference to the attached drawings, in which:

FIG. 1 is a perspective view of a pet waste removal device according to an embodiment of the present invention shown in an open state;

FIG. 2 is a side view of the pet waste removal device of FIG. 1;

FIG. 3 is a top view of the pet waste removal device of FIG. 1;

FIG. 4 is a front view of the pet waste removal device of FIG. 1;

FIG. 5 is a rear view of the pet waste removal device of FIG. 1;

FIG. 6 is a bottom view of the pet waste removal device of FIG. 1;

FIG. 7 is a perspective view of the pet waste removal device of FIG. 1 shown in a closed state;

FIG. 8 is a top view of the pet waste removal device of FIG. 1 shown in an unfolded state;

FIG. 9 is a perspective view of a pet waste removal device according to another embodiment of the present invention;

FIG. 10 is a front view of the pet waste removal device of FIG. 9;

FIG. 11 is a perspective view of the pet waste removal device of FIG. 9 shown in a closed state;

FIG. 12 is a flowchart showing tasks of a method of using a pet waste removal device according to an embodiment of the present invention;

FIG. 13 is a schematic view showing a task of the method of using a pet waste removal device of FIG. 12;

FIG. 14 is a schematic view showing another task of the method of using a pet waste removal device of FIG. 12;

FIG. 15 is a schematic view showing another task of the method of using a pet waste removal device of FIG. 12; and

FIG. 16 is a schematic view showing another task of the method of using a pet waste removal device of FIG. 12.

### DETAILED DESCRIPTION

Some exemplary embodiments will now be described more fully hereinafter with reference to the accompanying drawings; however, embodiments of the present invention may be embodied in different forms and should not be construed as limited to the exemplary embodiments illustrated and set forth herein. Rather, these exemplary embodiments are provided by way of example for understanding of the invention and to convey the scope of the invention to those skilled in the art.

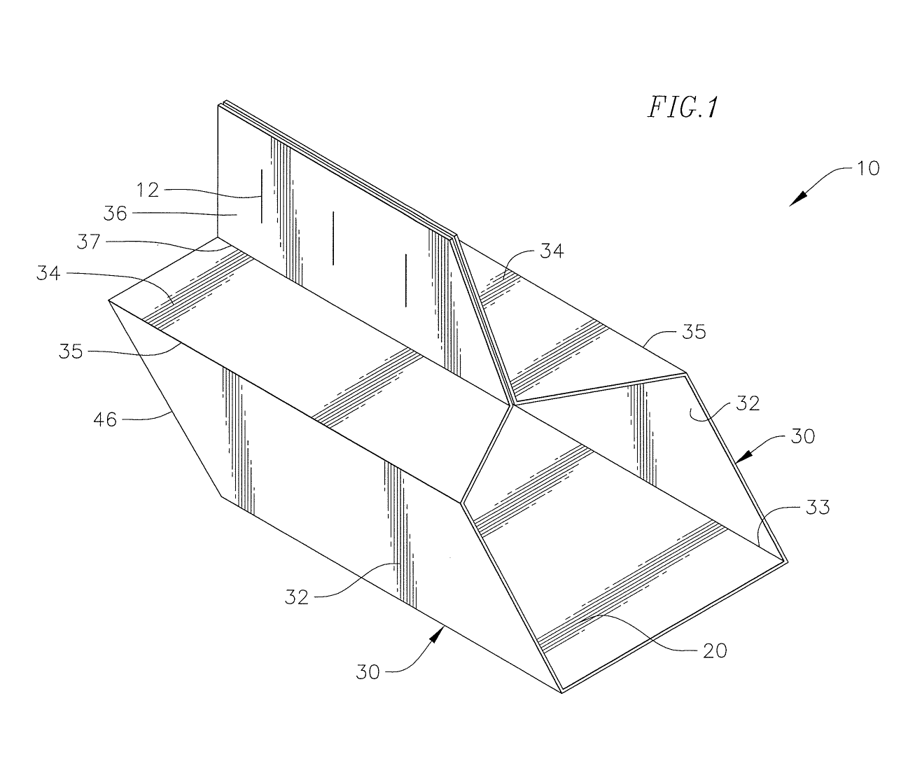

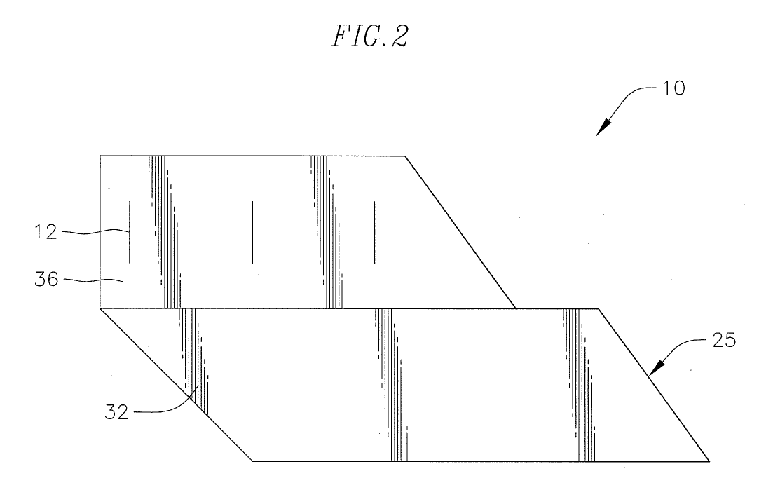

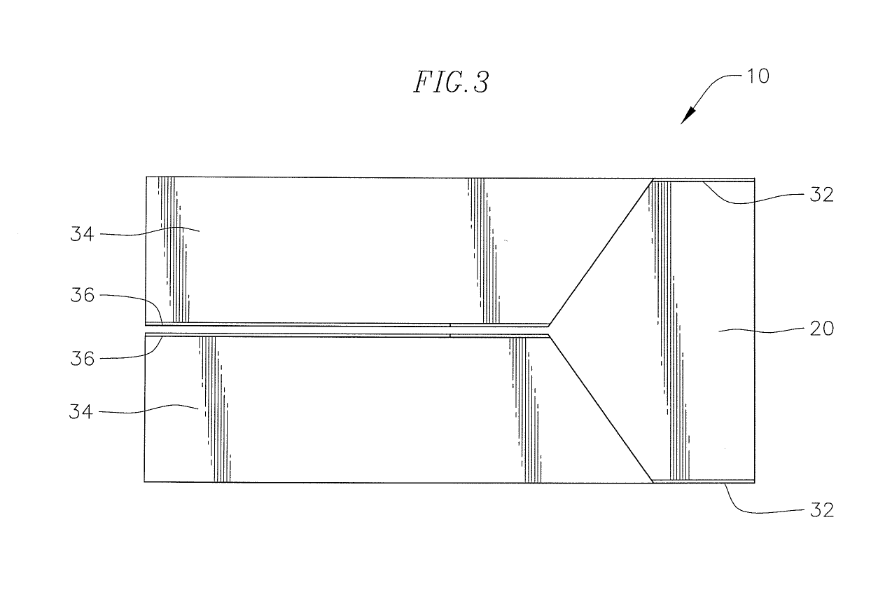

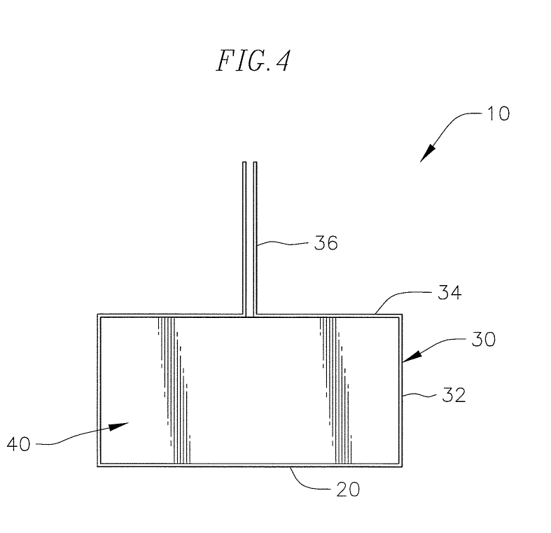

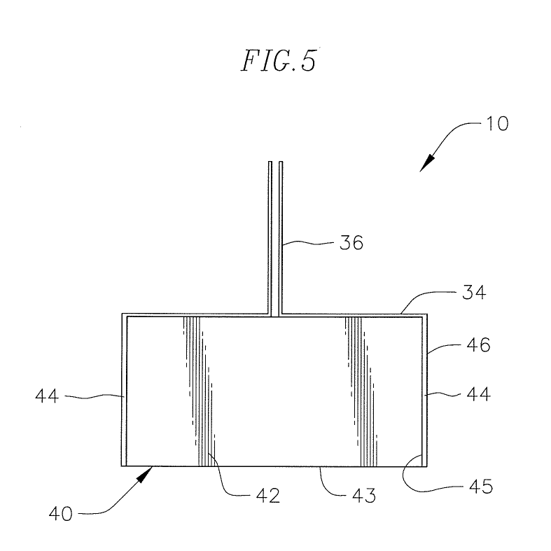

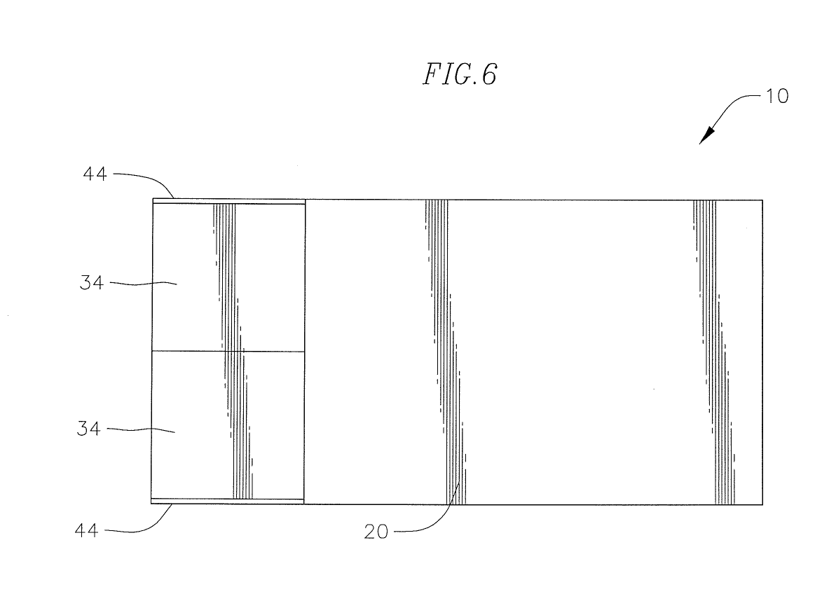

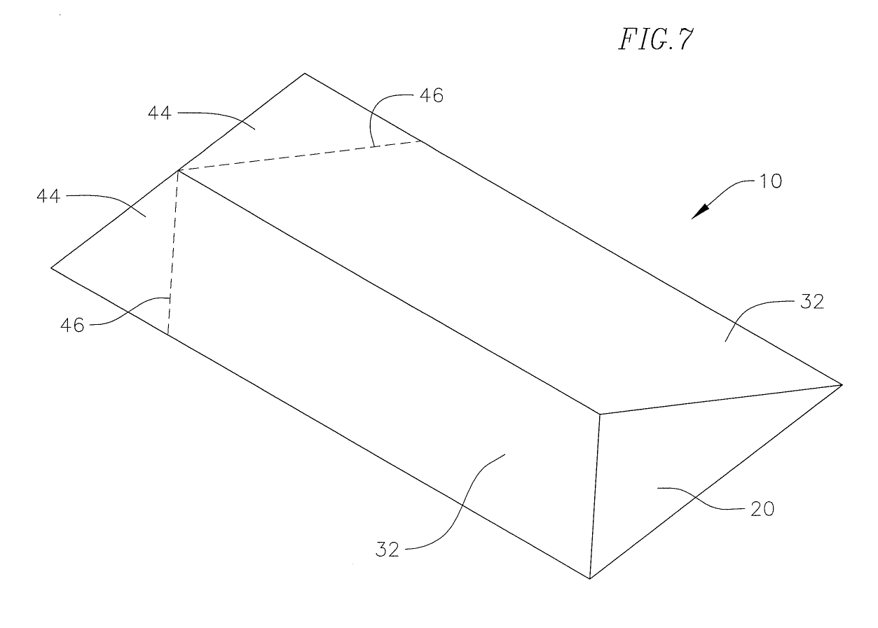

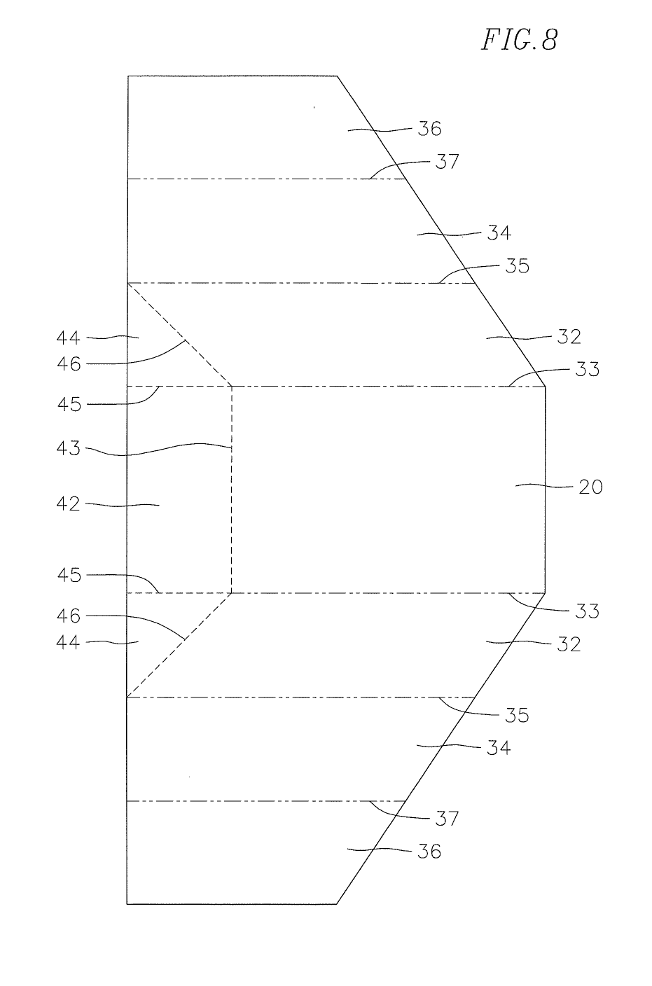

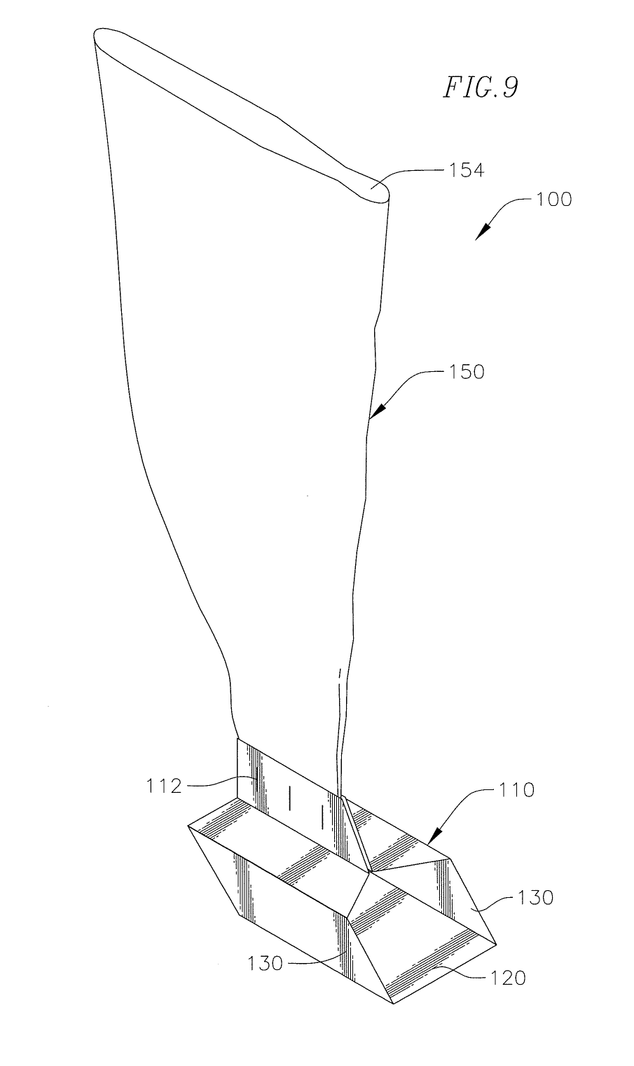

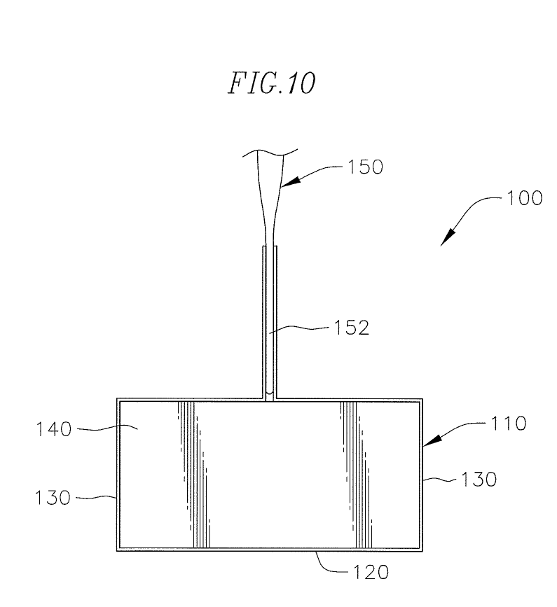

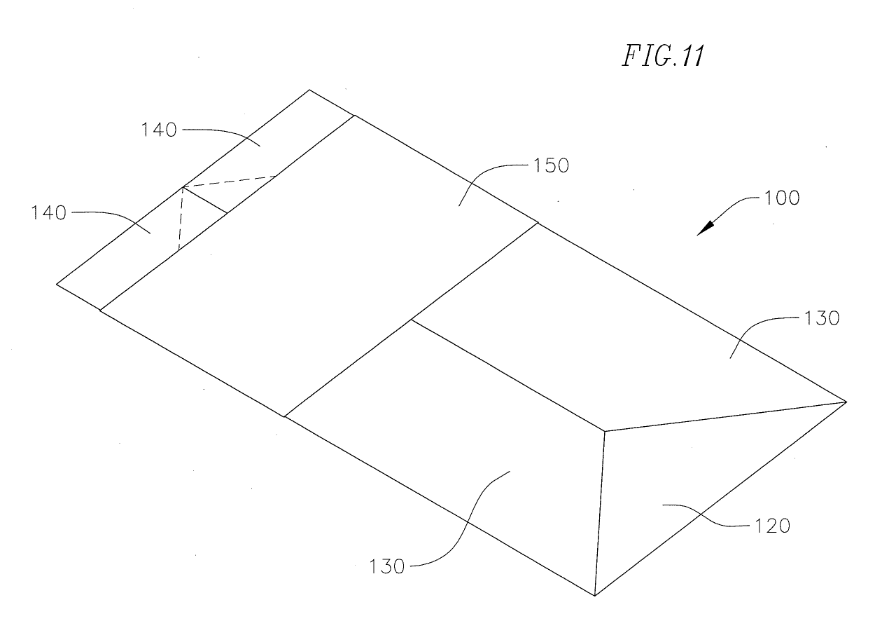

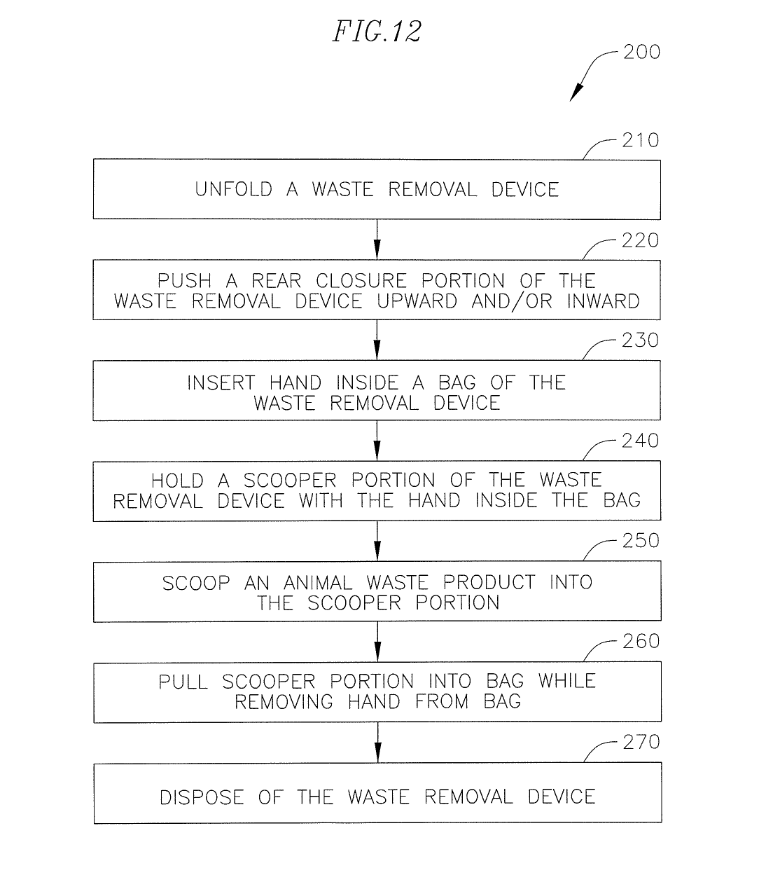

With reference to FIGS. 1-6, a pet waste removal device 10 according to an embodiment of the present invention includes a base portion 20, a pair of side portions 30 opposite each other, and a rear closure portion 40. The base portion 20 forms the bottom of the pet waste removal device 10 and is configured to scoop a waste product and hold the waste product inside the pet waste removal device 10. The side portions 30 extend from opposite sides of the base portion 20 and, in one embodiment, are connected to each other, such as near distal ends thereof. The closure portion 40 extends from a rearward end of the base portion 20 and extends between the side portions 30. The pet waste removal device 10, in one embodiment, is foldable between a closed position, or closed state, wherein the pet waste removal device 10 is substantially flat and an open position, or open state, wherein the side portions 30 extend upward from the opposite sides of the base portion 20 and are spaced apart from each other to define an opening 25 together with the base portion 20. Further, in one embodiment, the closure portion 40 extends upward from the rearward end of the base portion 20 to close an end of the pet waste removal device 10 opposite the opening 25 when the pet waste removal device 10 is in the open position.

The side portions 30, in one embodiment, extend from opposite sides of the base portion 20 and are joined to the base portion 20 at respective side portion fold lines 33. In one embodiment, the side portions 30 are foldable upward at the side portion fold line 33 relative to the base portion 20 for forming the opening 25 of the pet waste removal device 10. The side portions 30, in one embodiment, include first side portions 32 and second side portions 34. The second side portions 34, in one embodiment, are joined to the first side portions 32 at first side portion fold lines 35, and the second side portions 34 are foldable relative to the first side portions 32 at the first side portion fold lines 35. In one embodiment, when the pet waste removal device 10 is in the open position, the first side portions 32 are spaced apart from each other and extending upward from the base portion 20 to define the opening 25 together with the base portion 20. In one embodiment, the side portions 30 further include distal side portions 36 joined to the second side portions 34 at second side portion fold lines 37, and the distal side portions 36 are foldable relative to the second side portions 34 at the second side portion fold lines 37. In one embodiment, when the pet waste removal device 10 is in the open position, the second side portions 34 extend toward each other, and the distal side portions 36 extend upward to form a handle of the pet waste removal device 10. The side portions 30, in one embodiment, are connected to each other at the distal side portions 36 using staples 12 or any other suitable fastener or connecting device.

The closure portion 40, in one embodiment, extends from a rearward end of the base portion 20 and is joined to the base portion 20 at a closure portion fold line 43. Further, in one embodiment, the closure portion 40 is foldable upward at the closure portion fold line 43 relative to the base portion 20 for closing the rearward end of the pet waste removal device 10. In one embodiment, the closure portion 40 includes a center portion 42 and a pair of wing portions 44 extending from opposite sides of the center portion 42. Further, in one embodiment, the wing portions 44 are joined to the center portion 42 at respective closure portion fold lines 45, and the wing portions 44 are foldable relative to the center portion 42 at the respective closure portion fold lines 45. Also, in one embodiment, the wing portions 44 are joined to the respective first side portions 32 at respective wing portion fold lines 46, and the wing portions 44 are foldable relative to the respective first side portions 32 at the respective wing portion fold lines 46.

According to one embodiment, the pet waste removal device 10 is configured to be folded between an open position or state and a closed position or state. In other words, the pet waste removal device 10 may be configured to be folded and unfolded and, in one embodiment, refolded. For example, the pet waste removal device 10, according to one embodiment, may be folded to a closed position, as shown in FIG. 7. The pet waste removal device 10 has a substantially flat shape when in the closed position and, as such, is more portable when in the closed position because it may easily and conveniently be carried in a pocket, a purse or other bag, or by hand. Moreover, the pet waste removal device 10 may be more easily packaged, shipped, and/or stored while in the closed position. For example, the pet waste removal device 10 may be fabricated and folded to the closed position before shipment. Further, a plurality of units of the pet waste removal device 10 may be folded to the closed position and packaged together in a box or other container. In one embodiment, the pet waste removal device 10 is foldable to a left-hand side or a right-hand side, such that some units of a plurality of the pet waste removal device 10 may be folded to a left-hand closed position and packaged together with some units of the plurality of the pet waste removal device 10 that are folded to a right-hand closed position in order to save space. The pet waste removal device 10 is foldable to the open position for use in removing a pet waste product or other waste item.

The pet waste removal device 10, in one embodiment, is fabricated from a flat piece of material, as shown in FIG. 8. With further reference to FIG. 8, the various fold lines of the pet waste removal device 10 discussed above are shown in an unfolded state. In one embodiment, as depicted in FIG. 8, the second fold line, the closure portion fold lines, and the wing portion fold lines are perforated (depicted by a continuous dashed line), while the remaining fold lines are scored (depicted by an alternating dashed line). The perforated fold lines according to the above-described embodiment facilitate folding and/or maintaining the closure portion 140 in the upward, closed position. However, in other embodiments, the fold lines of the pet waste removal device 10 may have any other suitable configuration or combination thereof for facilitating folding of the pet waste removal device 10 between the closed position or the open position and/or maintaining the pet waste removal device 10 in either of such positions.

According to one embodiment, the pet waste removal device 10 is fabricated by folding the flat piece of material shown in FIG. 8 at the various fold lines and subsequently connecting the side portions 30 to each other near distal ends thereof (e.g., at the distal side portions 136). The side portions 30, in one embodiment, are connected to each other with staples 12. However, the present invention is not limited thereto and, in other embodiment, the side portions 30 may be connected to each other by any other suitable fastener or other device.

In one embodiment, the flat piece of material shown in FIG. 8 from which the pet waste removal device 10 is fabricated may be cardboard or paperboard. However, the present invention is not limited thereto and, in other embodiments, the pet waste removal device 10 may be fabricated from any other suitable material. In one embodiment, the material may be a recycled material, such as recycled paperboard. Further, in one embodiment, the pet waste removal device 10 is fabricated from a rigid, substantially rigid, or semi-rigid material suitable for folding and capable of holding its shape while containing a pet waste product. Additionally, in one embodiment, the pet waste removal device 10 is fabricated from an inexpensive and/or degradable material such that the pet waste removal device 10 is disposable. In one embodiment, the pet waste removal device 10 is about four inches long and has an opening having a generally rectangular shape having a width of about 2.5 inches and a height of about 1.25 inches. However, the present invention is not limited thereto and, in other embodiments, may have any other suitable shape and size.

With reference to FIGS. 9 and 10, a pet waste removal device 100 according to another embodiment of the present invention includes a scooper portion 110 and a bag portion 150. According to one embodiment, the scooper portion 110 is configured the same or similar to the pet waste removal device 10 described above. In one embodiment, the scooper portion 110 includes a base portion 120 configured to scoop a waste product and hold the waste product thereon; a pair of side portions 130 extending upward from opposite sides of the base portion 120 and spaced apart from each other to define an opening of the scooper portion 110 together with the base portion 120; and a closure portion 140 extending upward from a rearward end of the base portion 120 and extending between the side portions 130 to close an end of the scooper portion 110 opposite the opening. Each of the base portion 120, the side portions 130, and the closure portion 140, according to one embodiment, is the same or similar to the corresponding base portion 20, side portions 30, and closure portion 40 of the pet waste removal device 10 described above. Further, in one embodiment, the scooper portion 110 includes fold lines the same or similar to the fold lines 33, 35, 37, 43, 45, 46 of the pet waste removal device 10 described above.

The bag portion 150, in one embodiment, has a closed end 152 that is coupled to the scooper portion 110, and an open end 154 opposite the closed end 152. The bag portion 150, in one embodiment, is fabricated from an inexpensive and/or degradable material such that the pet waste removal device 100 is disposable. For example, in one embodiment, the bag portion 150 may be a degradable plastic bag.

In one embodiment, the closed end 152 of the bag portion 150 is coupled to the scooper portion 110 with staples 112. However, the present invention is not limited thereto and, in other embodiment, the bag portion 150 and the scooper portion 110 may be coupled to each other by any other suitable fastener or other device. Further, in one embodiment, the staples 112 connect the side portions 130 of the scooper portion 110 to each other while coupling the bag portion 150 to the side portions 130. According to one embodiment, the bag portion 150 is coupled to the scooper portion 110 such that the scooper portion 110 is receivable in the bag portion 150, such as by inverting (i.e. turning inside out) the bag portion 150 while pulling the scooper portion 110 into the bag portion 150.

With reference to FIG. 11, the pet waste removal device 100 is shown in a closed position. Similar to the pet waste removal device 10 described above, the pet waste removal device 100 is foldable between a closed position or state and an open position or state. The pet waste removal device 100 is substantially flat and, as such, may be more easily carried or stored, such as in a pocket or purse, while in the closed position, and is foldable to the open position for use in removing a pet waste product or other waste item. The scooper portion 110, in one embodiment, is foldable between the closed position and the open position in substantially the same manner as the pet waste removal device 10 described above. Further, in one embodiment, the bag portion 150 is neatly wrapped around the scooper portion 110 in the closed position and may be removably adhered to the scooper portion 110 with an adhesive device to prevent or substantially prevent the bag portion 150 from unraveling prior to folding the scooper portion 110 to the open position for use.

With reference to FIG. 12, a method 200 of using a pet waste removal device is shown. While the method 200 is described herein with respect to the pet waste removal device 100 described above and shown in FIGS. 9-11, the method 200, or at least some of the tasks thereof, may also be performed in using a pet waste removal device according to other embodiments of the present invention, such as the pet waste removal device 10 described herein.

With reference to FIG. 13, in one embodiment, the method 200 includes a task 210 of unfolding a waste removal device. For example, in one embodiment, the scooper portion 110 and the bag portion 150 of the pet waste removal device 100 may be unfolded. More specifically, the scooper portion 110 and the bag portion 150 may be folded from the closed position shown in FIG. 11 to the open position shown in FIG. 9 for use. With further reference to FIG. 13, the method 200, in one embodiment, includes a task 220 of pushing a rear closure portion (i.e. the closure portion 140 of the pet waste removal device 100) upward and/or inward toward the open end of the scooper portion 110 to close the rearward end for containing an animal waste product inside the scooper portion 110.

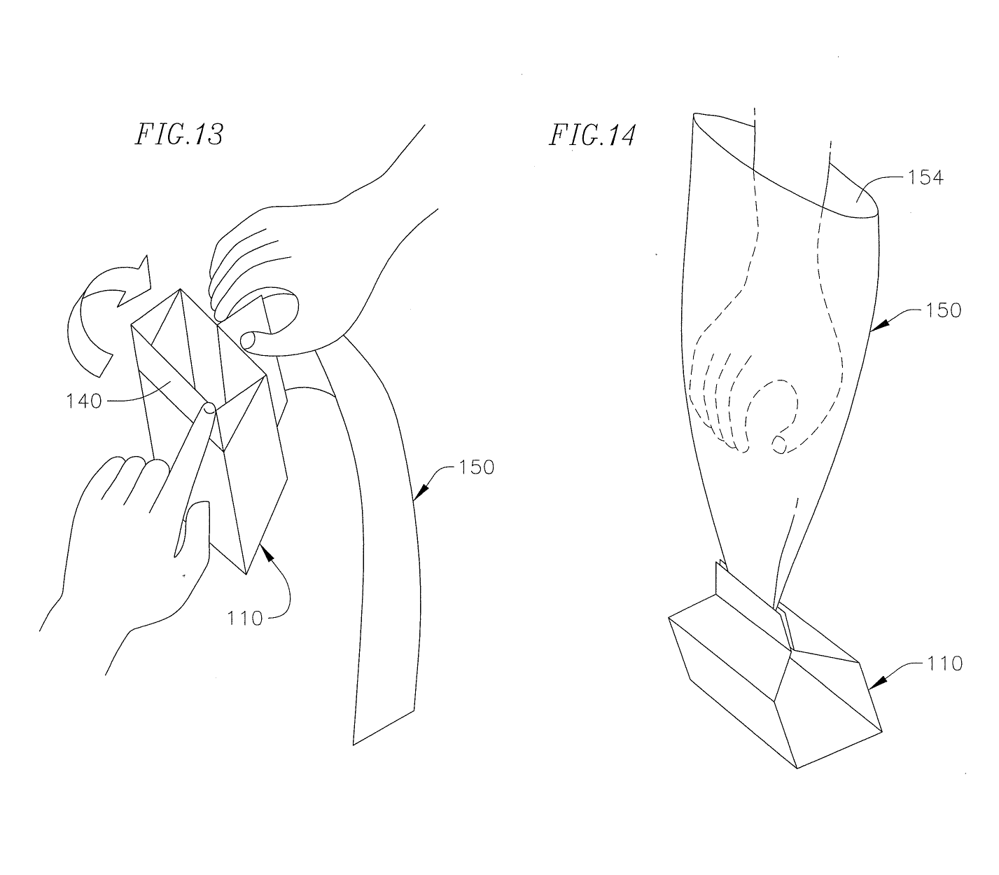

In one embodiment, as shown in FIG. 14, the method 200 includes a task 230 of inserting the user's hand inside the bag portion 150 of the waste removal device 100 through the open end 154 of the bat portion 150.

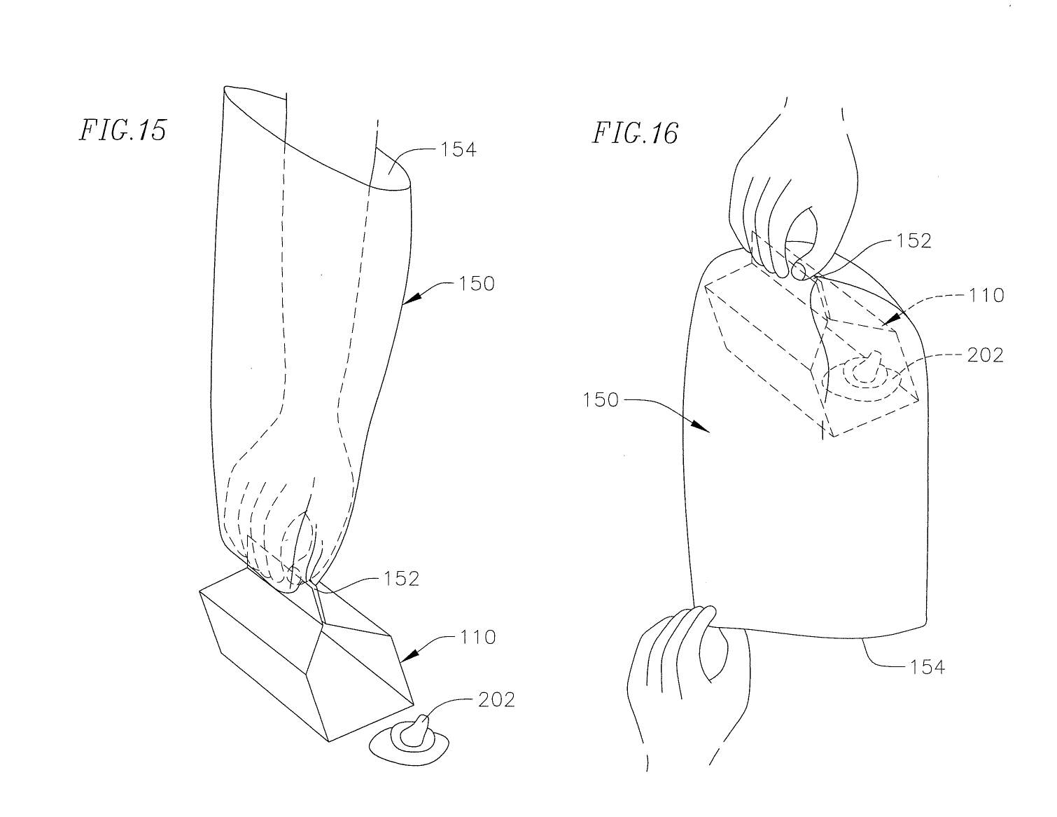

With reference to FIG. 15, in one embodiment, the method 200 includes a task 240 of holding the scooper portion 110 using the hand inside the bag portion 150 near the closed end 152 of the bag portion 150. For example, the scooper portion 110 may be held at the connected portions 136 of the side portions 130. With further reference to FIG. 15, the method further includes a task 250 of scooping an animal waste product 202 into the scooper portion 110. In one embodiment, the scooper portion 110 is moved with a scooping motion to scoop the animal waste product 202 through the opening of the scooper portion 110 and onto an upper surface of the base portion 120 of the scooper portion 110 such that the animal waste product 202 is contained in the scooper portion 110.

As shown in FIG. 16, in one embodiment, the method 200 further includes a task 260 of pulling the scooper portion 110 into the bag portion 150 while pulling the hand out of the bag portion 150 through the open end 154 of the bag portion 150. In one embodiment, the open end 154 of the bag portion 150 is held with a second hand while the first hand is pulled out of the bag portion 150. Further, in one embodiment, the bag portion 150 is inverted, or turned inside out, while pulling the scooper portion 110 upward into the bag portion 150 and pulling the first hand out of the bag portion 150.

The method 200, in one embodiment, further includes a task 270 of disposing of the pet waste removal device 100, such as into a garbage canister or other suitable disposal area. In one embodiment, the open portion 154 of the bag portion 150 may be closed and tied for disposal. According to an embodiment of the present invention, the pet waste removal device 100 is disposed of with the scooper portion 110 having the animal waste product 202 contained therein contained within the bag portion 150. In the method 200 of using a pet waste removal device described above, the user does not handle the animal waste product 202 directly or indirectly through the bag portion 150. Moreover, in the method 200 described above according to one embodiment, because the bag portion 150 is inverted (i.e. turned inside out) when the scooper portion 110 is pulled into the bag portion 150, an outer surface of the bag portion 150 which may have come into contact with the animal waste product 202 during scooping is reversed to the inside of the bag portion 150 for carrying and disposal such that the user may not inadvertently contact any portion of the animal waste product 202.

While in one embodiment, the method 200 of using a pet waste removal device may include each of the tasks described above and shown in FIG. 12, in other embodiments of the present invention, in a method of using a pet waste removal device, one or more of the tasks described above and shown in FIG. 12 may be absent and/or additional tasks may be performed. Further, in the method 200 of using a pet waste removal device according to one embodiment, the tasks may be performed in the order depicted in FIG. 12. However, in a method of using a pet waste removal device according to other embodiments of the present invention, the tasks described above and shown in FIG. 12 may be performed in any other suitable sequence.

Although the drawings illustrate the invention as applied to removing and disposing of solid waste of a pet or other animal, it will be apparent that the novel aspects of the waste removal device of the invention may also be applied to other applications. For example, aspects of embodiments of a waste removal device described herein may be applied to removal and/or disposal of other materials which are not desired to be handled, such as hazardous materials. Further, it will be apparent to those skilled in the art that a waste removal device may incorporate or embody various combinations of the embodiments described above with respect to the shapes, sizes, and components of the device, as well as alternatives not described herein, without departing from the spirit and scope of the present invention.

The preceding description has been presented with reference to some exemplary embodiments of the invention. Persons skilled in the art and technology to which this invention pertains will appreciate that alterations and changes in the described structures and methods of assembly and operation can be practiced without meaningfully departing from the principles, spirit, and scope of this invention.

What is claimed is:

1. A waste removal device comprising:
a base portion configured to scoop a waste product and hold the waste product thereon;
a pair of side portions comprising respective first side portions extending from opposite sides of the base portion; and
a closure portion extending from a rearward end of the base portion and extending between the side portions,
wherein the side portions are connected to each other near distal ends thereof, and
wherein the waste removal device is foldable between a closed state wherein the waste removal device is substantially flat and an open state wherein the first side portions extend upward from the opposite sides of the base portion and are spaced apart from each other to define an opening together with the base portion and wherein the closure portion extends upward from the rearward end of the base portion to close an end of the waste removal device opposite the opening.

2. The waste removal device of claim 1, wherein the base portion is joined to the respective side portions at respective first fold lines and is joined to the closure portion at a second fold line, and the waste removal device is foldable at the first and second fold lines between the closed state and the open state.

3. The waste removal device of claim 1, wherein the base portion, the side portions, and the closure portion comprise a substantially rigid material.

4. The waste removal device of claim 1, wherein the base portion, the side portions, and the closure portion comprise cardboard.

5. The waste removal device of claim 1, wherein:
the side portions further comprise respective second side portions,
the first side portions are joined to the respective second side portions at respective first side portion fold lines, and the side portions are foldable at the respective first side portion fold lines between the closed state and the open state, and
the side portions are connected to each other at the second side portions.

6. The waste removal device of claim 5, wherein the second side portions include respective second side portion fold lines, and the second side portions are foldable at the respective second side portion fold lines between the closed state and the open state.

7. The waste removal device of claim 1, wherein the side portions are stapled to each other.

8. The waste removal device of claim 1, wherein:
the closure portion comprises a center portion and a pair of wing portions extending from opposite sides of the center portion, and
the wing portions are joined to the center portion at respective closure portion fold lines, and the wing portions are foldable relative to the center portion at the respective closure portion fold lines between the closed state and the open state.

9. The waste removal device of claim 8, wherein:
the wing portions are joined to the respective first side portions at respective wing portion fold lines, and the wing portions are foldable relative to the respective first side portions at the respective wing portion fold lines between the closed state and the open state, and
the wing portions are substantially parallel to the respective first side portions when the waste removal device is in the open state.

10. The waste removal device of claim 1, wherein:
the base portion is joined to the respective side portions at respective first fold lines and is joined to the closure portion at a second fold line, and the waste removal device is foldable at the first and second fold lines between the closed state and the open state,
the closure portion comprises a center portion and a pair of wing portions extending from opposite sides of the center portion, and
the wing portions are joined to the center portion at respective closure portion fold lines and are joined to the respective first side portions at respective wing portion fold lines, and the wing portions are foldable relative to the center portion at the respective closure portion fold lines and are foldable relative to the respective first side portions at the respective wing portion fold lines between the closed state and the open state.

11. The waste removal device of claim 10, wherein the second fold line, the closure portion fold lines, and the wing portion fold lines are perforated.

12. A waste removal device comprising:
a scooper portion comprising:
a base portion configured to scoop a waste product and hold the waste product thereon;
a pair of side portions extending upward from opposite sides of the base portion and spaced apart from each other to define an opening of the scooper portion together with the base portion; and
a closure portion extending upward from a rearward end of the base portion and extending between the side portions to close an end of the scooper portion opposite the opening; and
a bag portion coupled to the scooper portion.

13. The waste removal device of claim 12, wherein the scooper portion is receivable in the bag portion.

14. The waste removal device of claim 12, wherein the waste removal device is foldable into a substantially flat shape.

15. The waste removal device of claim 12, wherein the scooper portion comprises cardboard.

16. The waste removal device of claim 12, wherein the side portions and the bag portion are stapled to each other.

17. A method of using a waste removal device including a scooper portion having a base portion, a pair of side portions extending from opposite sides of the base portion, and a closure portion extending from a rearward end of the base portion, the method comprising:
unfolding the scooper portion from a folded state to an unfolded state wherein the side portions extend upward from the base portion and are spaced apart from each other to define an opening of the scooper portion together with the base portion;
pushing the closure portion inward toward the opening to close the rearward end of the scooper portion; and
scooping a waste product onto the base portion through the opening.

18. The method of claim 17, wherein pushing the closure portion inward toward the opening to close the rearward end of the scooper portion comprises folding the closure portion at a perforated fold line thereof.

19. The method of claim 17, further comprising:
opening a bag portion coupled to the scooper portion;
inserting a hand inside the bag portion;
and holding the scooper portion with the hand inside the bag portion.

20. The method of claim 19, further comprising inverting the bag portion and pulling the scooper portion into the bag portion while removing the hand from the bag portion.
